(19) United States
(12) Patent Application Publication
(10) Pub. No.: US 2026/0280598 A1
(43) Pub. Date: Sep. 17, 2026

(54) MULTI PURPOSE CONFIGURABLE WIRELESS TRANSCEIVER SYSTEM ON CHIP

(71) Applicant: Ceragon Networks Ltd., Rosh HaAyin (IL)

(72) Inventors: Anton BEDINERMAN, Rosh HaAyin (IL); Yoav HEIMAN, Beit Horon (IL); Amir PERELSTAIN, Kfar-Saba (IL); Ehud LAVIE, Tel Aviv (IL)

(73) Assignee: Ceragon Networks Ltd., Rosh HaAyin (IL)

(21) Appl. No.: 19/471,745

(22) PCT Filed: Feb. 7, 2024
(86) PCT No.: PCT/IL2024/050146

§ 371 Date: Oct. 2, 2025

Related U.S. Application Data
(60) Provisional application No. 63/456,550, filed on Apr. 3, 2023.

(51) Int. Cl. H04B 1/40; G06F 13/40; H04B 1/00

(52) U.S. Cl. CPC H04B 1/40; G06F 13/4063; H04B 1/005; G06F 2213/40

(57) ABSTRACT

Available and non-allocated MACC structures implemented as parallel hardware processing units are re-used to implement a plurality of signal processing options using a multiplexing of signals within a System on Chip (SoC) having a configurable transmitter and receiver. The SoC has a Network Sub-System is connected to a network. A Modem Sub-System couples to the Network Sub-System, where the Modem Sub-System comprises a receiver and transmitter circuit having multiplexing circuits and control hardware for providing parallel hardware units for processing low bandwidth signals. A Host Sub-System having a processor couples to the network, the Network Sub-System, and the Modem Sub-System, wherein in response to an application programming interface (API) call from the network, the Host Sub-System configures the Network Sub-System and configures the Modem Sub-system.

### RELATED APPLICATION/S

This application claims the benefit of priority of U.S. Provisional Patent Application No. 63/456,550, filed on Apr. 3, 2023, the contents of which are incorporated herein by reference in their entirety.

### BACKGROUND

The description relates to the dynamic configuration of multi-band wireless transceiver integrated circuits adapted for a system on chip (SOC) use and manufacture.

The disclosures of all references mentioned above and throughout the present specification, as well as the disclosures of all references mentioned in those references, are hereby incorporated herein by reference.

### SUMMARY

The present disclosure, in some embodiments thereof, relates to performing dynamic configuration of multi-band transceivers integrated circuits adapted for a system on chip (SOC) use and manufacture.

According to some aspects, a System on Chip (SoC) has a configurable receiver comprises the following elements. The SoC has a Network Sub-System connected to a network. A Modem Sub-System couples to the Network Sub-System, where the Modem Sub-System comprises a receiver circuit having multiplexing circuits and control hardware for providing parallel hardware units for processing low bandwidth signals. A Host Sub-System having a processor couples to the network, the Network Sub-System, and the Modem Sub-System, wherein in response to an application programming interface (API) call from the network, the Host Sub-System configures the Network Sub-System and configures the Modem Sub-system.

In some aspects of the configurable receiver, the API call can configure the Modem SubSystem multiplexing circuits and control hardware; the Network Sub-System for packet processing and radio bonding and enable at least one Ethernet port. In some aspects of the configurable receiver, a configuration of the Network Sub-System connects a plurality of line configurations to the network. In some aspects of the configurable receiver, the Modem Sub-System has a receiver circuit for at least one of a microwave frequency; a D-Band frequency; or an E-band frequency. In some aspects of the configurable receiver the Modem Sub-System having parallel hardware units are a plurality of finite impulse response (FIR) filter implementations allowing cross polarization interference cancelation (XPIC); carrier aggregation; decimation and bi-directional side-lobe cancellation. In some aspects of the configurable receiver, the plurality of FIR filters concatenate to increase the number of FIR taps. In some aspects of the configurable receiver, the CCI couples a plurality of configurable receivers and network channels. In some aspects of the configurable re-ceiver, has one configurable receiver as a master and at least one configurable receiver is a slave. In some aspects of the configurable receiver, the CCI couples at least two configurable receivers having at least one output port.

According to some aspects, a System on Chip has a configurable transmitter comprising the following elements. A Network Sub-System connected to a network. A Modem Sub-System couples to the Network Sub-System, the Modem Sub-System comprises a transmitter circuit having multiplexing circuits and control hardware for providing parallel hardware units for processing low bandwidth signals, and a host subsystem having a processor coupled to the network, the Network Sub-System, and the Modem Sub-System, for configuring the Network Sub-System and for configuring the Modem Sub-System in response to an application programming interface (API) call from the network.

In some aspects, the configurable transmitter uses an API call configures the Modem Sub-System multiplexing circuits and control hardware; an Ethernet channel connection to a carrier for the Network Sub-System; and enable an Ethernet port. In some aspects, the configurable transmitter configures the Network Sub-System is for packet processing, radio bonding, and connecting a plurality of line configurations to the network. In some aspects, the configurable transmitter configuring the Modem Sub-System is having a transmitter circuit for at least one of a microwave frequency; a D-Band frequency; or an E-band frequency. In some aspects, the configurable transmitter Modem Sub-System is having parallel hardware units are a plurality of FIR filter implementations allowing carrier aggregation; bi-directional side-lobe cancellation, and beam-forming. In some aspects, the configurable transmitter the plurality of FIR filters can concatenate to increase the number of FIR taps. In some aspects, the configurable transmitter the CCI couples a plurality of configurable transmitters configured for parallel transmitting. In some aspects, the configurable transmitter one configurable transmitter is configured as a master and coupling to at least one configurable transmitter configured as a slave. In some aspects, the configurable transmitter the CCI couples at least two configurable transmitters configured for parallel transmitting with at least one input port. In some aspects, the configurable transmitter further comprising a clock synchronizer circuit for interfacing to several clock sources and capable to select the best clock source, the clock synchronizer circuit configured by an API call.

Unless otherwise defined, all technical and/or scientific terms used herein have the same meaning as commonly understood by one of ordinary skill in the art to which the disclosure pertains. Although methods and materials similar or equivalent to those described herein can be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present disclosure may be embodied as a system, method or computer program product. Accordingly, some embodiments of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present disclosure may take the form of a computer program product embodied in one or more computer readable medium(s) having computer readable program code embodied thereon. Implementation of the method and/or system of some embodiments of the disclosure can involve performing and/or completing selected tasks manually, automatically, or a combination thereof. Moreover, according to actual instrumentation and equipment of some embodiments of the method and/or system of the disclosure, several selected tasks could be implemented by hardware, by software or by firmware and/or by a combination thereof, e.g., using an operating system.

For example, hardware for performing selected tasks according to some embodiments of the disclosure could be implemented as a chip or a circuit. As software, selected tasks according to some embodiments of the disclosure could be implemented as a plurality of software instructions being executed by a computer using any suitable operating system. In an exemplary embodiment of the disclosure, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the disclosure. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present disclosure may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present disclosure may be described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

### BRIEF DESCRIPTION OF THE SEVERAL VIEWS OF THE DRAWINGS

Some embodiments of the disclosure are herein described, by way of example only, with reference to the accompanying drawings. With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

In the drawings.

FIG. 1A is an example high-level block diagram illustrating a System on Chip (SoC) having Dynamically Configurable Transceiver Pairs (DCTPs).

FIG. 1B is an example block diagram illustrating a Host System embedded in System on Chip (SoC) having Dynamically Configurable Transceiver Pairs (DCTPs).

FIG. 1C is an example block diagram illustrating a Network Sub-System (NSS) that is embedded in System on Chip (SoC) having Dynamically Configurable Transceiver Pairs (DCTPs).

FIG. 1D is an example block diagram illustrating a Modem Sub-System embedded in System on Chip (SoC) having Dynamically Configurable Transceiver Pairs (DCTPs).

FIG. 2A is an example high-level block diagram illustrating a Dynamically Configurable Transceiver Pair (DCTP) with a processor and a cross connect interface (CCI).

FIG. 2B is an example high-level block diagram illustrating a Dynamically Configurable Transceiver Pair (DCTP) with a processor and a cross connect interface (CCI) and a first example interfacing to an antenna.

FIG. 3 is an example high-level block diagram example illustrating a dynamically configurable Bi-Directional system having a first DCTP coupled to a second DCTP coupled via a CCI.

FIG. 4 is an example high-level block diagram illustrating a dynamically configurable quad-system having four DCTP modules coupled via a CCI.

FIG. 5 is an example high-level block diagram illustrating a dynamically configurable quad-DCTP coupled Master-Slave system with one antenna.

FIG. 6 is an example high-level block diagram illustrating a dynamically configurable quad-DCTP coupling to an external aggregator or switch with one antenna.

FIG. 7 is an example high-level block diagram illustrating a dynamically configurable E-band dual carrier

FIG. 8 is an example high-level block diagram illustrating a dynamically configurable E-band dual carrier with XPIC.

FIG. 9 is an example high-level block diagram illustrating a dynamically configurable E-band-wide band single carrier with a direct connection to an antenna.

FIG. 10 is an example high-level block diagram illustrating a dynamically configurable D-band single carrier having up to 4 kQAM with a direct connection to an antenna.

FIG. 11 is an example high-level block diagram illustrating a Bi-Directional Antenna System having a first DCTP coupled to a second DCTP coupled via a CCI.

FIG. 12 is an example high-level block diagram illustrating a Quad DCTP coupled an external switch.

FIG. 13 is an example Dynamically Configurable Multi-Band transceiver.

FIG. 14 is an example using 2 N taps long multiply accumulators (MACC) units to implement two N taps long finite impulse responses (FIRs) processing two separate inputs.

FIG. 15 is an example FIR implementation of even and odd inputs to two multiply accumulators having decimation using 2 N taps long MACC units to implement two N taps long FIRs processing two separate inputs.

FIG. 16 is an example FIR implementation of even and odd inputs to two multiply accumulators having a double rate using 2 N taps long MACC units to implement two N taps long FIRs processing two separate inputs.

FIG. 17 shows an example of a single input signal connected to two MACCs with a 2N number of taps using concatenation.

FIG. 18 shows an example of a quad input signal connected to four MACCs having a 4N FIR input rate with 4-X output rate.

FIG. 19 shows an example quad input signal connected to four multiply accumulators (MACC).

FIG. 20 shows an example clock synchronizer circuit schematic.

FIG. 21 is a is a high-level flowchart of the System on Chip initialization.

### DETAILED DESCRIPTION

The present disclosure, in some embodiments thereof, relates to performing dynamic changes in dividing communications for sending over at least one link, and, more particularly, but not exclusively, to performing dynamic changes in dividing communications for sending over a first bi-directional path which enables gathering data relating to communications sent over a second path.

Before explaining at least one embodiment of the disclosure in detail, it is to be understood that the disclosure is not necessarily limited in its application to the details of construction and the arrangement of the components and/or methods set forth in the following description and/or illustrated in the drawings and/or the Examples. The disclosure is capable of other embodiments or of being practiced or carried out in various ways.

The Dynamically Configurable Wireless Transceiver is a programmable/dynamic transmitter/receiver (transceiver) module that has a cross-connect circuit to allow a parallelism of operation for coupling and uncoupling of transmitters and receivers to increase and decrease the bandwidth, increasing and decreasing frequencies of operation, or coupling and decoupling to different modems via a cross-connect interface bus which allows for bi-directional and quad-directional configurations at micro-wave up to D-band frequencies. There is a pure parallel mode and a Master Slave mode.

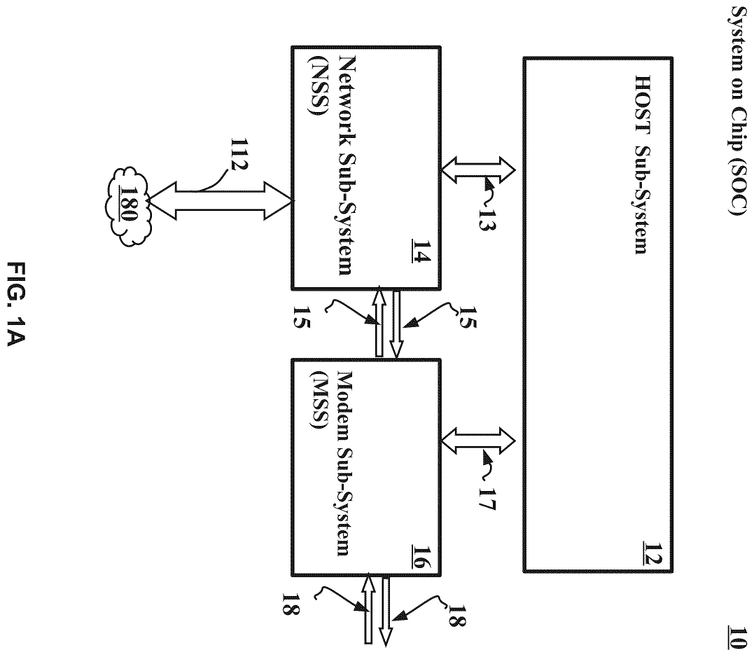

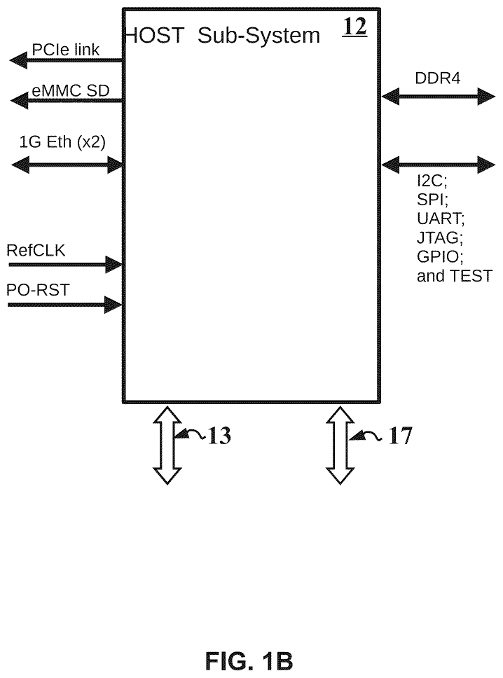

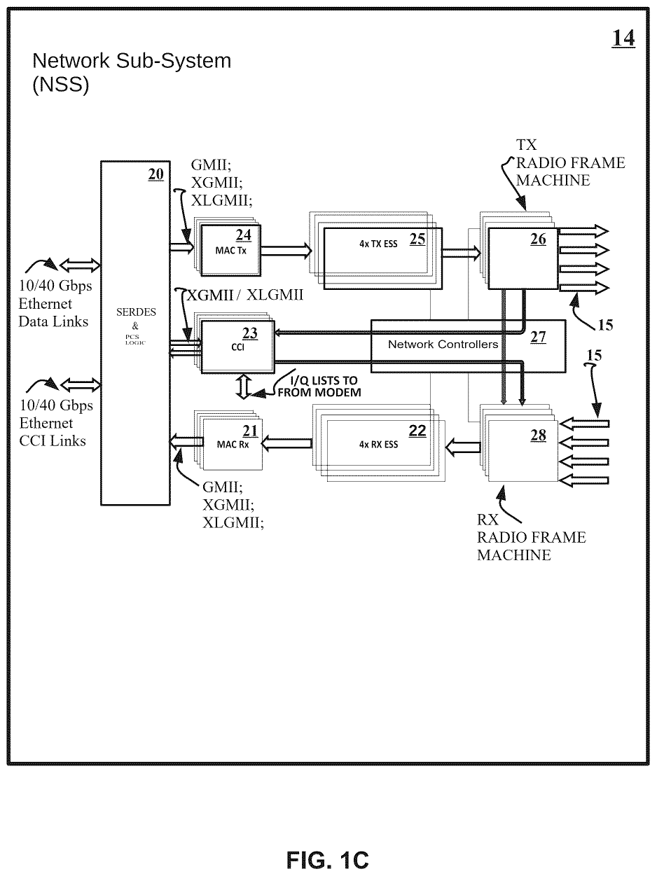

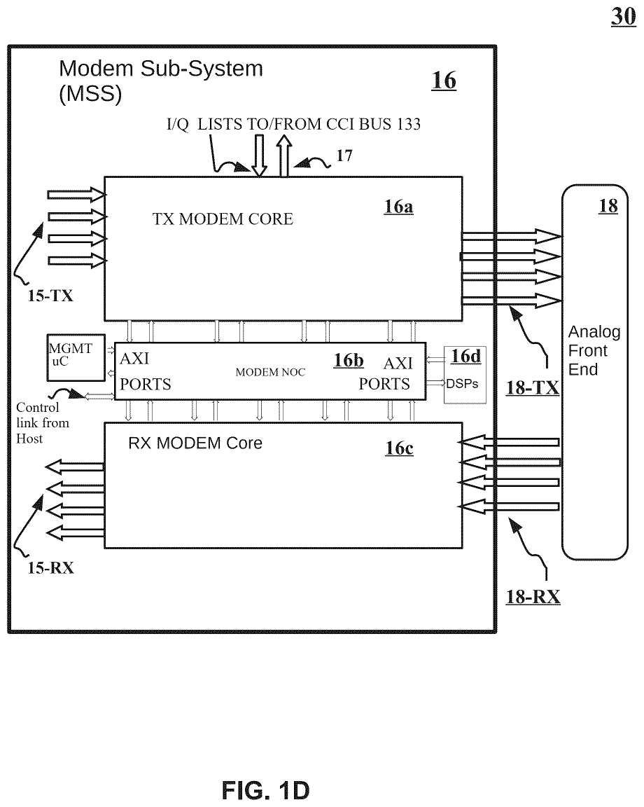

Referring now to FIG. 1A, an example high-level block diagram illustrating a System on Chip (SoC) 10 having Dynamically Configurable Transceiver Pairs (DCTPs). There are three major blocks, the host subsystem 12, the Network Sub-System (NSS) 14, and the Modem Sub-System (MSS) 16. The host connects to the NSS via 13 and to the MSS via 17 for transferring commands, data. Buses 15 connect the NSS to the MSS. The MSS outputs via bus 18 to an analog front end (AFE). The NSS connects via 112 to a network as shown below 180.

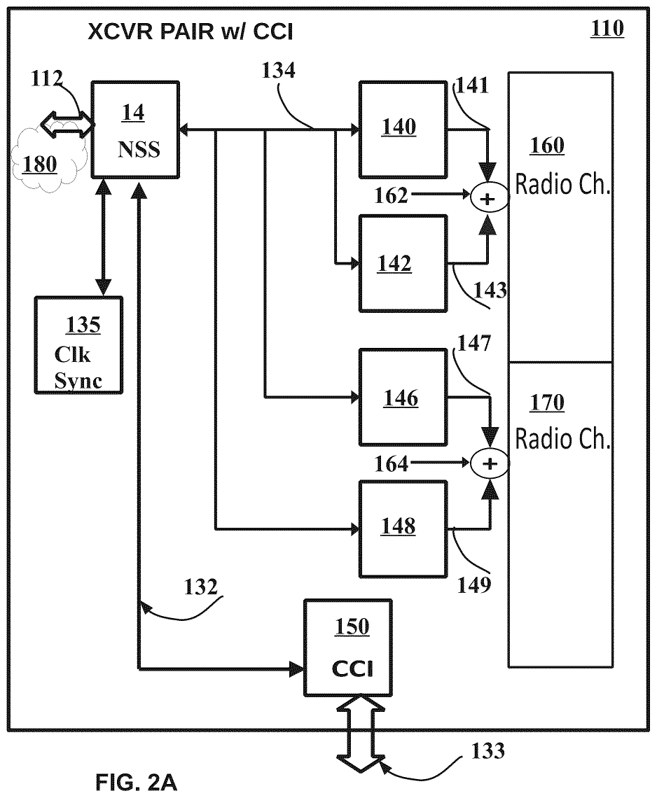

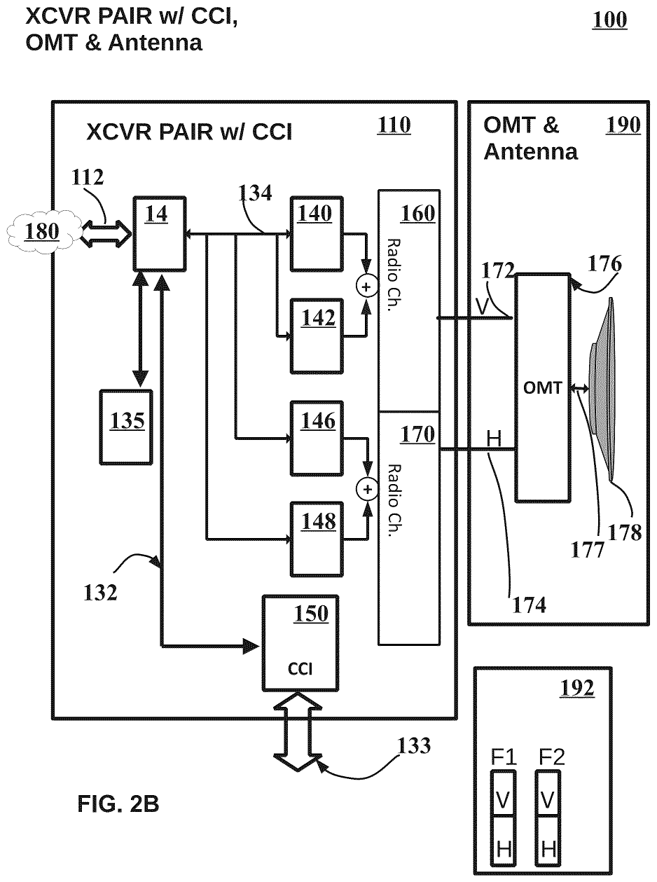

According to some implementations, the MSS has a plurality of Dynamically Configurable Transceiver Pairs (DCTPs) implementing the modem functions of the SoC. The DCTP circuit is described in more detail below in FIG. 2A and is often referred to throughout the disclosure when disclosing modem functionality.

Referring now to FIG. 1B, an example block diagram illustrates a host subsystem 12 embedded in the SoC having Dynamically Configurable Transceiver Pairs (DCTPs). The host comprises logic and circuitry to support the inputs and output buses and signals having function comprising: PCIe Link; eMMC SD; two 1G Ethernet links; reference clock; power-on reset; DDR4 memory bus; and low speed signals—I²C, SPI, UART; JTAG; GPIO and test. The host also supports communications between the NSS via 13 and the MSS via 17.

Referring now to FIG. 1C, an example block diagram illustrates a Network Sub-System (NSS) 14 that is embedded in SoC having Dynamically Configurable Transceiver Pairs (DCTPs). The NSS interfaces to the network, cloud, and has a Radio Framer machine to build frames of data. The NSS 14 has a Serializer/Deserializer (SerDes) block 20 connects to 10/40 Gbps Ethernet data links and 10/40 Gbps Ethernet cross connect interface links. In some exemplary cases, the data links can be 100 Gbps, 25 Gbps or another rate. The SerDes 20 further connects via gigabit media-independent interface, GMII, IEEE 802.3ae 10 Gigabit XGMII, and IEEE 802.3ba 100 Gigabit XLGMII to a plurality of media access controllers (MACs) transmit 24 blocks and a plurality of MAC receive blocks 21. Data is input and output from the MAC block via four transmit Ethernet Sub-System (ESS) blocks 25 and four receive (RX) blocks 22. Radio Framer machine for transmit 26 and receive 28 connect to the ESS blocks. Four CCI blocks 23 connect to the SerDes 20. Network controller 27 manages the CCI 23, Radio Framer 26 and 28 and the ESS 22 and 25. The Radio Framer 26 and 28 connect to the MSS via buses 15.

Blocks 25 and 22, Ethernet Sub-System (ESS). includes packet processing modules. The ESS enables the SoC to analyze and compress packets, determine their priority, and send them to the radio according to this priority. The ESS also handles PTP1588 packets time-tagging.

In some aspects, the Network Sub-System has multiplexing circuits and control hardware for providing parallel hardware units for processing multiple data paths in parallel. In some aspects, the Host Sub-System configures the Network Sub-System in response to an application programming interface (API) call from the network. Optionally, the NSS 14 connect a plurality of line configurations to the network.

FIG. 1D is an example block diagram 30 illustrates a Modem Sub-System 16 embedded in System on Chip (SoC) having Dynamically Configurable Transceiver Pairs (DCTPs). 17 bus sends and receives I/Q lists from the CCI bus 133. An input bus 15-TX from the NSS connects to a transmit modem core 16a and an output bus 18-TX connects to an analog front end 18. An output bus 15-RX to the NSS connects to a RX modem core 16c and an input bus 18-RX connects to an analog front end 18. A modem Network Operation Center (NOC) 16b with DSP support 16d connects via Advanced extensible Interface (AXI) ports to the TX modem core 16a and RX modem core 16c. In some aspects, the MSS has a management processor connected to the modem NOC 16b.

Referring now to FIG. 2A, an example high-level block diagram with system 110 illustrates the integrated circuit implementation of a Dynamically Configurable Wireless Transceiver shown as a Dynamically Configurable Transceiver Pair (DCTP) module 110 with a processor, a clock synchronizing circuit and a cross connect circuit.

The illustration of system 110 comprises the Dynamically Configurable Transceiver Pair with a CCI bus 133. The DCTP block 110 comprises a bus interface 112 connecting to the network 180. An external network switch can couple to bus 112 to handle the communications and to provide traffic to the NSS 14.

The NSS 14 handles all communications with the network 180 using a memory to store, parse, and retrieve data and can dynamically configure the plurality of transmitter and receiver circuits by executing a receiver or transmitter code. The code is configured to (a) dynamically allocate a radio capacity and choose a modulation from a group comprising: 64 Quadrature Amplitude Modulation (QAM); 128-QAM; 256-QAM, and up to 4 kQAM; (b) choose a receiver or transmission carrier frequency selected from the group comprising from microwave frequency bands through millimeter wave, up to D-band and; and (c) interface with a network and parse the plurality of frames to the memory.

The NSS 14 is operative and capable of sending and receive via the bus 134 frames from transmitters and receivers in the DCTP. In some aspects, transmitters and receivers in the DCTP send and receive via the bus 134 frames, having an equal-sized payload from each transceiver. The Bus 134 couples a first pair of modulator circuit blocks 140 and 142 for converting a plurality of frames to I/Q analog data. The bus 134 couples a second pair of modulator circuits, blocks 146 and 148, for converting a plurality of frames to a plurality of I/Q analog data. A first adder 162 couples to the first pair of modulator circuits, blocks 140 via bus 141 and modulator circuit 142 via bus 143 for transmitting and receiving I and Q analog data having a vertical-polarity via a first radio channel 160. A second adder 164 couples to the second pair of modulator circuit block 146 via bus 147 and modulator circuits block 148 via bus 149 for transmitting and receiving I and Q analog data having a horizontal-polarity.

A clock synchronization circuit 135 can interface to the NSS 14 to provide clocking for the transmitter, receiver circuits, and CCI bus 133. In some aspects, the clock synchronization circuit 135 interfaces directly to the internal bus 132, and 134 bus.

Block 150 is the CCI circuit for providing data, management command and clocks to additional Dynamically Configurable Transceiver Pair modules for several configurations as described further in the specification.

Referring now to FIG. 2B, an example high-level block diagram with system 100 illustrating the Dynamically Configurable Wireless Transceiver shown as a Dynamically Configurable Transceiver Pair (DCTP) module with a cross connect and Orthomode transducer (OMT) coupling to an antenna. An OMT is a waveguide component for microwave communications. Orthomode transducers operate on orthogonally polarized microwave signal paths. The waveguide is an uplink path for transmitting and a downlink path for receiving.

In some aspects, system 100 further comprising two modules, a first Dynamically Configurable Transceiver Pair with a CCI bus 133 as described above in FIG. 2A and a second OMT and antenna module 190. The OMT and Antenna block module 190 comprise a transducer 176 coupled to the first adder and coupled to a first radio channel 160 via 172 for transmitting and receiving I and Q analog data having the vertical-polarity. The transducer 176 couples to the second adder and couples to a second radio channel 170 for transmitting I and Q analog data having the horizontal-polarity 174. The transducer 176 is an orthomode transducer and couples via the transmission path 177 to the antenna 178. The frequencies of block 192, a first F1 frequency with a horizontal polarity and vertical-polarity and a second F2 frequency with a horizontal-polarity and vertical-polarity to an antenna 178.

In some aspects, an exemplary dynamically configurable transceiver pair is further comprising carrier aggregation and cross-polarization interference-cancellation, wherein the dynamic radio capacity and frequencies of transmission are selected from a group comprising: (1) 8 Gbps at 4×214 Mhz; (2) 4 Gbps at 4×112 Mhz; (3) 2 Gbps 4×56 Mhz; and (4) 1 Gbps at 4×28 Mhz. Cellular carrier aggregation can increase the data rate per user by assigning where the same user multiple frequency blocks, known as component carriers. The maximum data rate per user can increase by assigning more frequency blocks to a user. Cross-polarization interference-cancellation (XPIC) corrects orthogonality loss incurred during propagation so that the system optimally reconstructs both signals at the receiver. The bandwidth values listed are examples and not limiting.

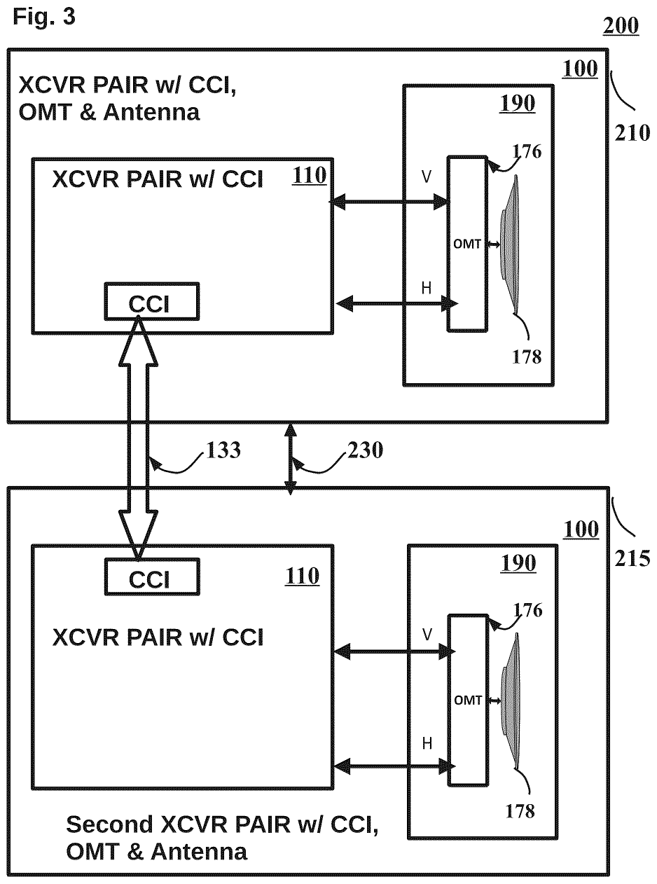

FIG. 3 is an example high-level block diagram illustrating a dynamically configurable Bi-Directional system having a first DCTP coupled to a second DCTP coupled via a CCI. System 200 is illustrating two Dynamically Configurable Transceiver Pairs, blocks 210 and 215. Block 210 couples to block 215 via the CCI bus 133 for traffic and management. The I/Q analog data, Multiple-Input Multiple-Output (MIMO), source and clock sharing are via 230. In some aspects, the CCI bus is plurality of connections configured by an API calls. MIMO can multiply a radio link capacity by using multiple transmission and receiving antennas to exploit multi-path propagation.

In one aspect, the cross-connect interface is a bus to allow parallelism of DCTP modules for the sharing of data and configuration command. In one aspect, the cross-connect interface is bi-directional. The CCI can support the following modes: parallelism, Master-Slave Mode, star configurations, etc. In some aspects, DCTP modules share one input-port/output-port. In some configurations, each DCTP module uses its own dedicated input-port/output-port. Optionally, each DCTP module uses two input-port/output-port each, with 4 ports in total. A dual DCTP module configuration may use two input-ports/output-ports each, having 4 ports in total. A quad DCTP module configuration may use two input-ports/output-ports each, 8 ports in total. In some configurations, 4 DCTP modules use four input-ports/output-ports each, 16 ports in total.

In one aspect, an exemplary system for a dynamically configurable transceiver pair supports carrier aggregation, cross-polarization with interference-cancellation. The cross-connect interface (CCI) circuit couples to a second DCTP. The dynamic radio capacity, frequencies of transmission and the CCI data rate is selected from a group consisting of: (1) 8 Gbps at 4×214 Mhz having a CCI data rate of 32 Gbps and no carrier aggregation; (2) 8 Gbps at 8×112 Mhz having a CCI data rate of 32 Gbps; (3) 4 Gbps 8×56 mhz having a CCI data rate of 16 Gbps; and (4) 2 Gbps at 8×28 Mhz having a CCI data rate of 8 Gbps.

In one aspect, an exemplary system having a DCTP supports bi-directional side-lobe cancellation. The dynamic radio capacity, frequencies of transmission and the CCI data rate is selected from a group consisting of: (1) 2×2 Gbps at 112 Mhz having a CCI data rate of 32 Gbps having no carrier aggregation; (2) 2×2 Gbps at 56 Mhz having a CCI data rate of 32 Gbps; (3) 2×1 Gbps at 28 MHz having a CCI data rate of 16 Gbps.

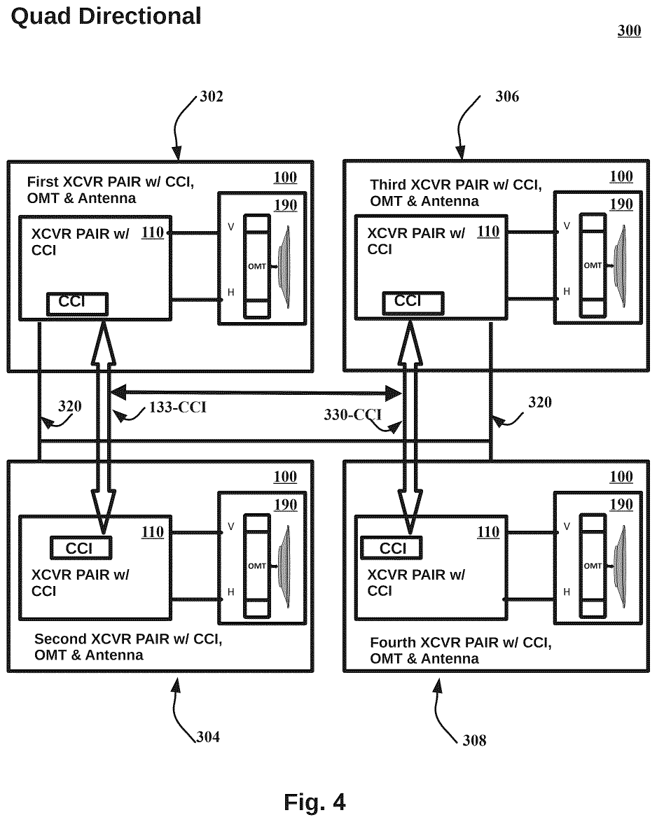

Referring to FIG. 4, an example high-level block diagram illustrates a dynamically configurable quad-system having four DCTP modules coupled via a CCI System 300 comprises four instantiations blocks, 302, 304, 306, and 308 of Dynamically Configurable Wireless Transceivers blocks 100 interconnect via a CCI bus 133 and clocking via 320 for source and clock sharing. In some aspects, the clocking is point to point from a first 302 block.

In some aspects, a cross-polarization interference-cancellation and the cross-connect interface (CCI) circuit couples to a second, third and fourth DCTPs. The four transmitters further comprises quad directional side-lobe cancellation, wherein the dynamic radio capacity, frequencies of transmission and the CCI data rate is selected from a group consisting of: (1) 4×1 Gbps at 56 MHz having a CCI data rate of 2×16 Gbps for each; and (2) 4×0.5 Gbps at 28 MHz having a CCI data rate of 2×8 Gbps. In some aspects, there is beam-forming and two directional side-lobe cancellation, wherein the dynamic radio capacity, frequencies of transmission. The CCI data rate is selected from a group consisting of: (1) 2×2 Gbps at 56 MHz having a CCI data rate of 2×16 Gbps having no carrier aggregation; and (2) 2×1 Gbps at 28 MHz having a CCI data rate of 2×8 Gbps having carrier aggregation. In some aspects, the system configuration allows a reuse of the transmitting frequency with a limitation of the angle between the antennas connected to the DCTP module blocks: 302, 304, 306, and 308 is 45 degrees.

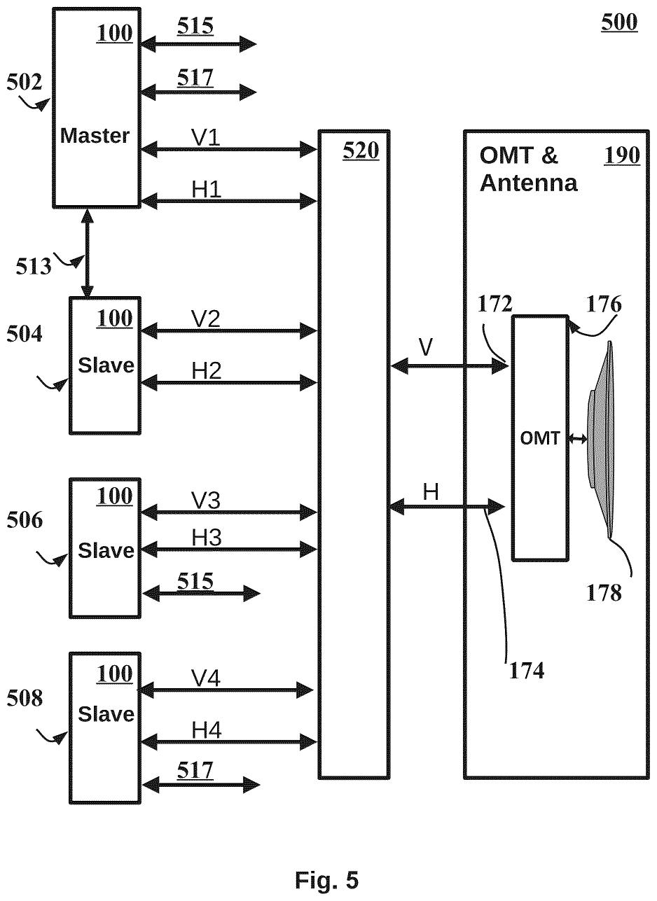

FIG. 5 is an example high-level block diagram 500 illustrating a dynamically configurable quad-DCTP coupled Master-Slave system with one antenna. Four DCTP instantiated as blocks 502, 504, 506, and 508 comprise the system 100. Block 502 acts as a master and interfaces to block 504 via interfaces 513. Block 504 interfaces to: (1) block 504 via CCI interface 513, (2) block 506 via CCI interface 515, and (3) block 508 via CCI interface 517. In some aspects, the CCI has a data rate of 4×10 Gbps. The four blocks 502, 504, 506, and 508 interface to a block 520 with pairs of vertical-polarity and horizontal-polarity paths via V1-4 and H1-H4. Block 520 is a signal aggregator and interfaces to OMT and antenna block 190. The signal aggregator 520 comprises a plurality of discrete ports for coupling to a plurality of vertical and horizontal transmission paths. The signal aggregator 520 couples the plurality of discrete ports to a common vertical port and a common horizontal port via a distinct transmission path extending there-between the signal aggregator. In some aspects, the cross-connect interface (CCI) circuit as a master coupled point-to-point in a star configuration to a second, third, and fourth DCTP, wherein the dynamic radio capacity, frequencies of transmission, and the CCI data rate is selected from a group consisting of: (1) 8 Gbps at 8×112 MHz; (2) 4 Gbps 8×56 MHz; and (4) 2 Gbps at 8×28 MHz.

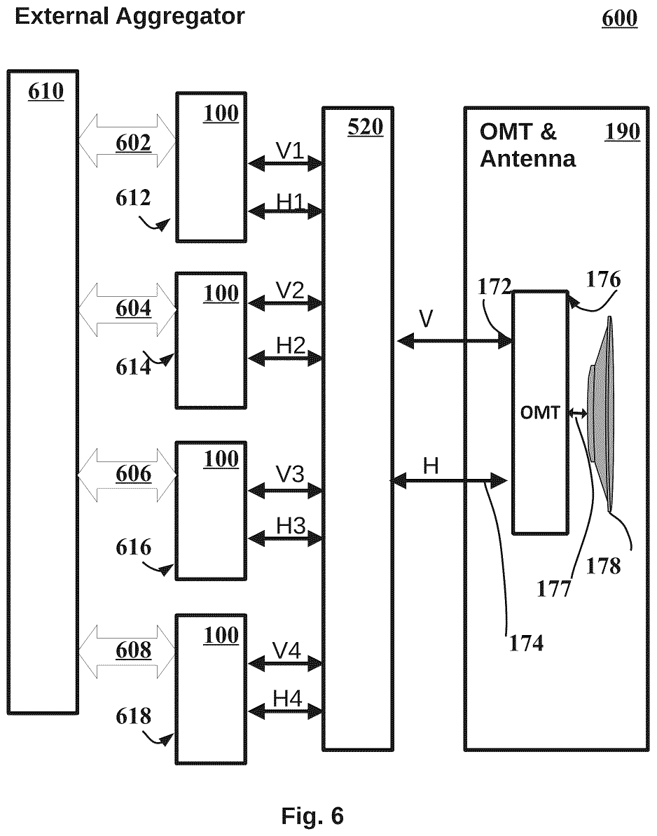

FIG. 6 is an example high-level block diagram 600 illustrating a dynamically configurable quad-DCTP coupled to an external switch with one antenna. Four DCTP modules are instantiations of blocks 612, 614, 616, and 618 comprise the system 100. Blocks 612, 614, 616and 618 interface to an external aggregator 610 via the buses 602, 604, 606, and 608. The four blocks 612, 614, 616, and 618 interface to a block 520 with pairs of vertical-polarity and horizontal-polarity paths via V1-4 and H1-H4. Block 520 interfaces to OMT and antenna block 190. In some aspects, four DCTPs couple to an aggregator switch, wherein the dynamic radio capacity, frequencies of transmission, and the CCI data rate is selected from a group consisting of: (1) 32 Gbps at 8×448 MHz; (2) 16 Gbps 8×214 MHz; (3) 8 Gbps 8×112 MHz; (4) (2) 4 Gbps 8×56 MHz; 2 Gbps at 8×28 MHz.

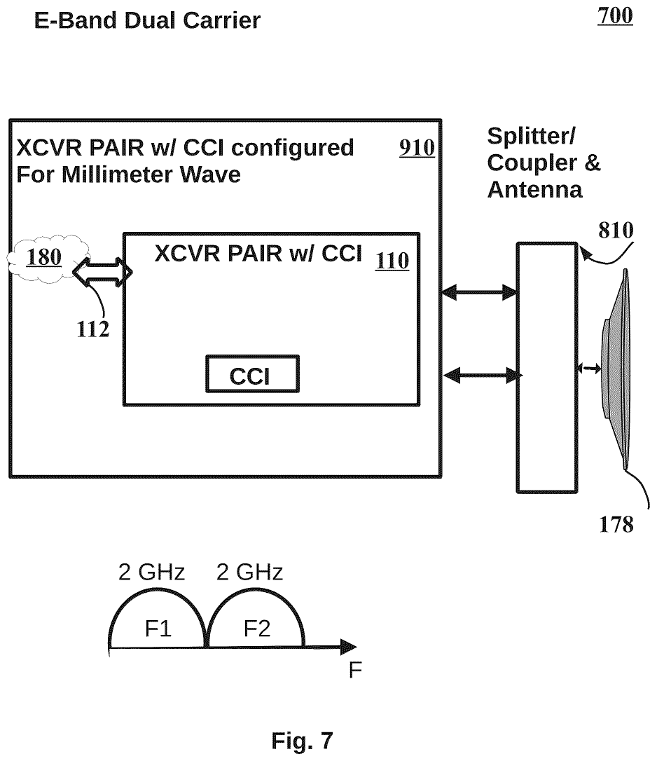

FIG. 7 is an example high-level block diagram 700 illustrating a dynamically configurable E-band dual carrier. System 700 comprises the block 910 comprising the module 110 configured as a millimeter wave transceiver pair configured for the millimeter wave operation and couples to a block 810, comprising a splitter or a coupler.

Optionally, the dynamically configurable wireless transceiver is a dynamically configurable millimeter-wave transceiver. In some aspects, the dynamic radio capacity of the DCTP is 2×12.5 Gbps, having a 2 GHz bandwidth (BW) configured for up to 4 k QAM on an E-band dual carrier.

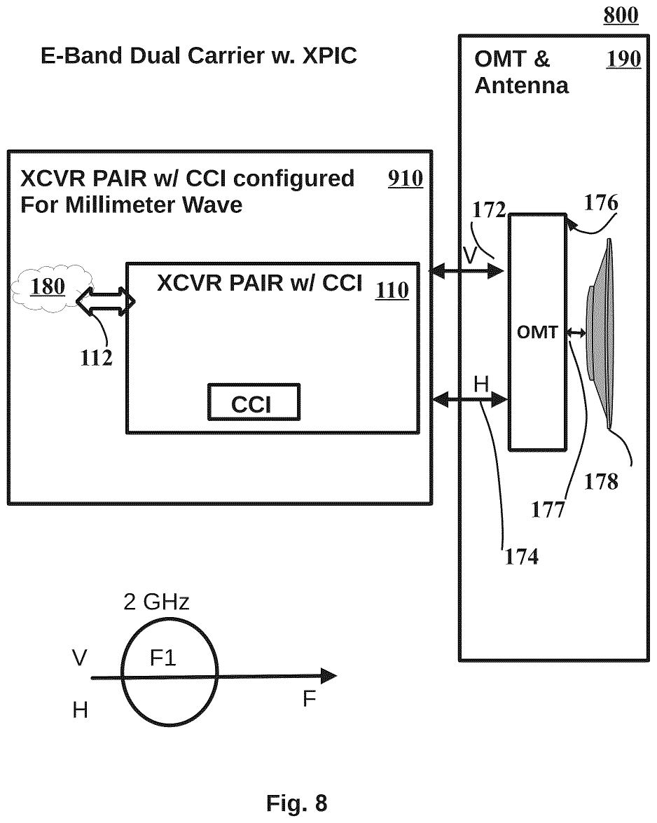

FIG. 8 is an example high-level block diagram 800 illustrating a dynamically configurable E-band dual carrier with cross-polarization interference-cancellation (XPIC) technology. In system 800, the block 910 comprises the module 110 configured as a millimeter wave transceiver pair configured for the millimeter wave operation and couples to block 910 described above in FIG. 2B. In some aspects, the dynamic radio capacity of the DCTP is 2×12.5 Gbps having a 2 GHz bandwidth configured for up to 4 k QAM on an E-band dual carrier.

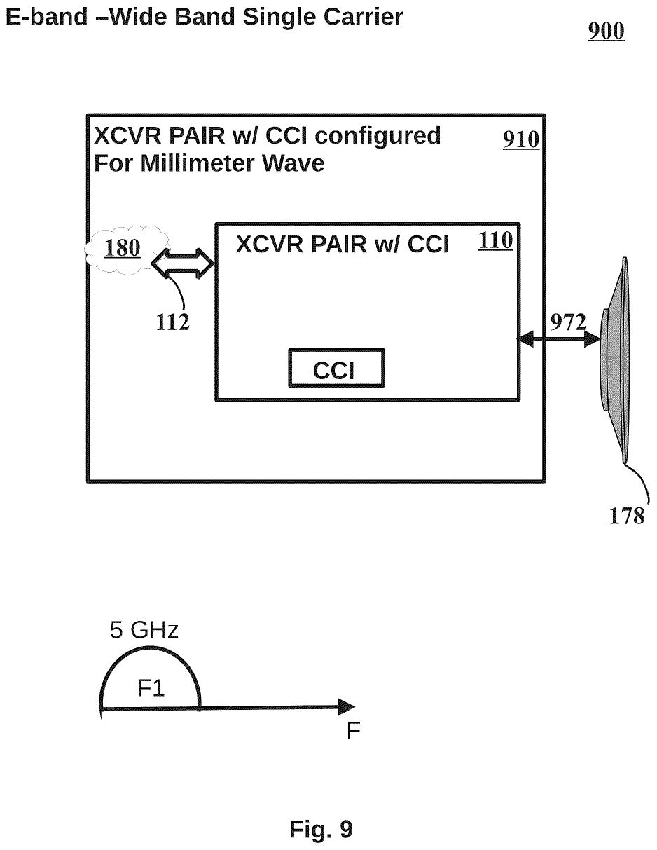

FIG. 9 is an example high-level block diagram 900 illustrating a dynamically configurable E-band wide band single carrier with a direct connection to an antenna. Antenna 178 couples via bus 972 directly to the first radio channel 160. In some aspects, the transceiver uses a dynamic radio capacity of 25 Gbps having a 5 GHz bandwidth configured for up to 4 k QAM on a single carrier.

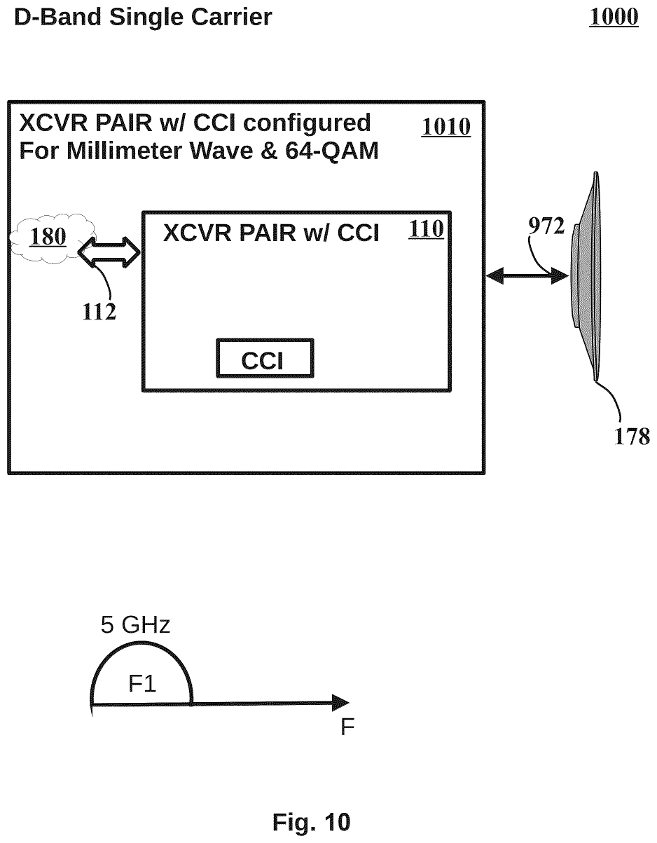

FIG. 10 is an example high-level block diagram 1000 illustrating a dynamically configurable D-band single carrier with a direct connection 972 to an antenna. In some aspects, the transceiver uses a dynamic radio capacity of 25 Gbps having a 5 GHz bandwidth configured for up to 4 k QAM on a single carrier.

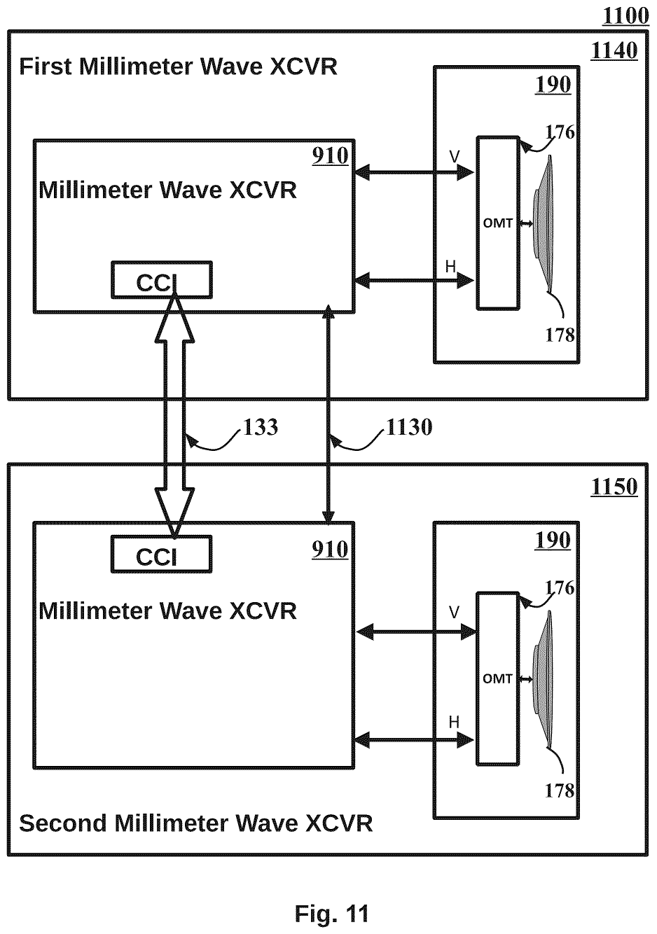

FIG. 11 is an example high-level block diagram 1100 illustrating a Dual DCTP illustrating a dynamically configurable system having a first DCTP coupled to a second DCTP coupled via a CCI bus 133. System 1100 is illustrating two Dynamically Configurable Transceiver Pairs, blocks 1140 and 1150. Block 1140 couples to block 1150 via the external CCI bus 133 for data and management, where clock source sharing, and I/Q analog data for MIMO is via 1130. The total dynamic radio capacity is 50 Gbps at a 2 GHz bandwidth configured for up to 4 kQAM and further comprising XPIC.

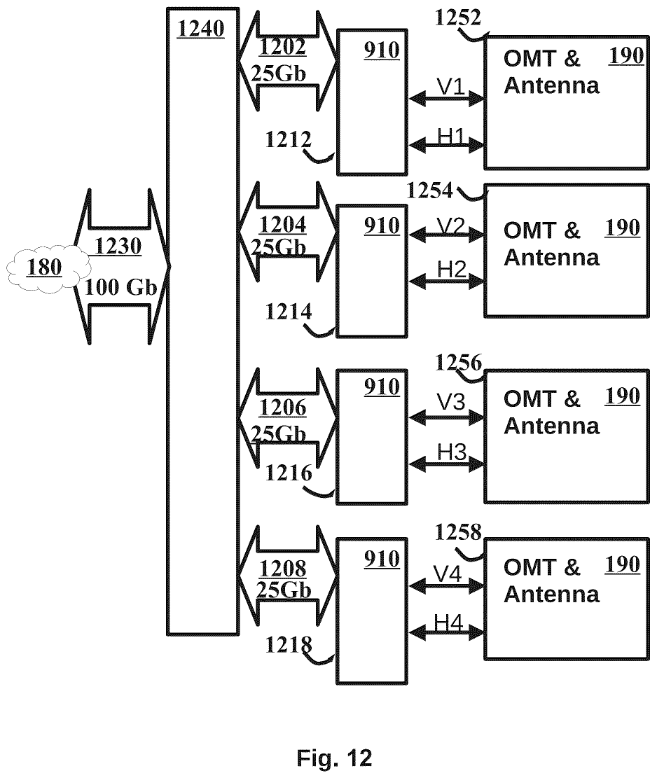

FIG. 12 is an example high-level block diagram 1200 illustrating a Quad DCTP coupled with an external switch. System 1200 coupling to the network 180 via a bus 1230 at a rate of 100 Gbps or more through an external aggregator 1240. Four channels, 1202, 1204, 1206, and 1208, each capable of 25 Gbps of data capacity couple to external aggregator and four blocks 1212, 1214, 1216, and 1218. The four blocks further couple to four OMT and Antenna modules 1252, 1254, 1256, and 1258, each containing the instance 910 described above in FIG. 2B.

In some aspects, the quad DCTPs couple to an external switch, wherein the dynamic radio capacity is 100 Gbps at a 2×2 GHz bandwidth configured for up to 4 kQAM, and further comprising XPIC.

The block pair 1212 and 1214 and the block pair 1216 and 1218 couple together as disclosed on FIG. 11 above using the CCI bus 133 for data and management, as well as the clock source sharing, and I/Q analog data for MIMO via 1130.

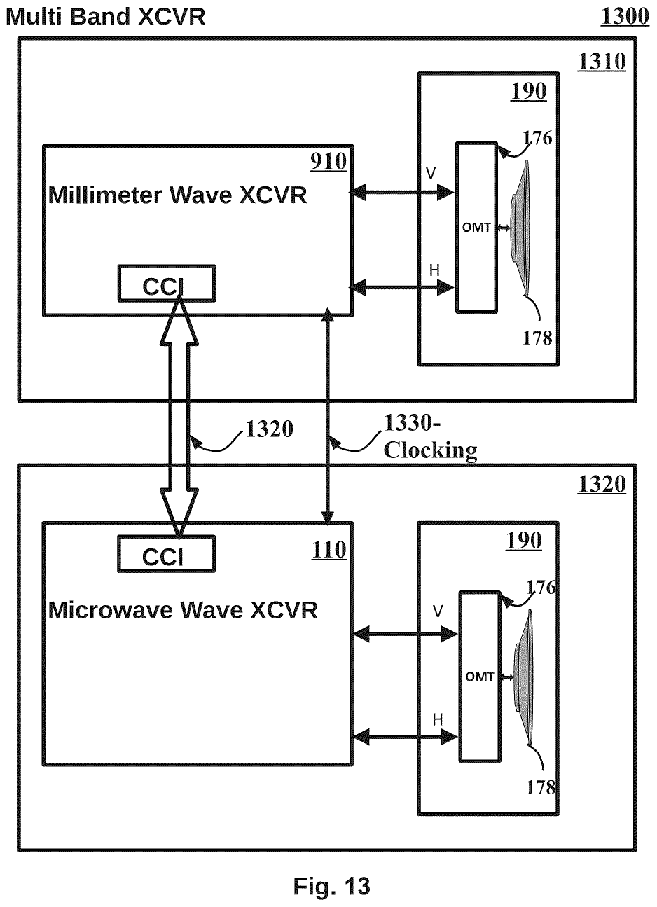

FIG. 13 is an example high-level block diagram 1300 illustrating an example Dynamically Configurable Multi-Band transceiver. In some aspects, the radio capacity is 25 Gbps millimeter-wave and 8 Gbps microwave with a data sharing via the CCI bus having 8 Gbps for 33 Gbps radio capacity. In some aspects, the multiband configuration can be achieved by a single SoC or by multiple SoCs

### Multiply Accumulate Structure;

The following figures show examples of various MACC structures. In some embodiments the MACC structures are implemented as parallel hardware units. The disclosure intends to show the re-use of the same MACC structures to implement different signal processing options using multiplexing of signals. Therefore, the first 4 lines in Table-1 listed below describes how the same 2 MACCs are used for implementing four distinct filtering options. The usage of the same hardware allows all options as a configurable circuit. The 2 last lines show an example of how this can be expanded to more than 2 MACCs. In some aspects, 4×N taps long MACC-s are used as a single N long FIR with ×4 FIR input rate and ×4 quad output rate. In some aspects, additional MACC units further increase the rate. In some aspects, there are 16 MACC units in a parallel implementation. Different processing options, such as the options introduced in lines 1-4 of Table-1, can be implemented for 4 or more MACC units as well.

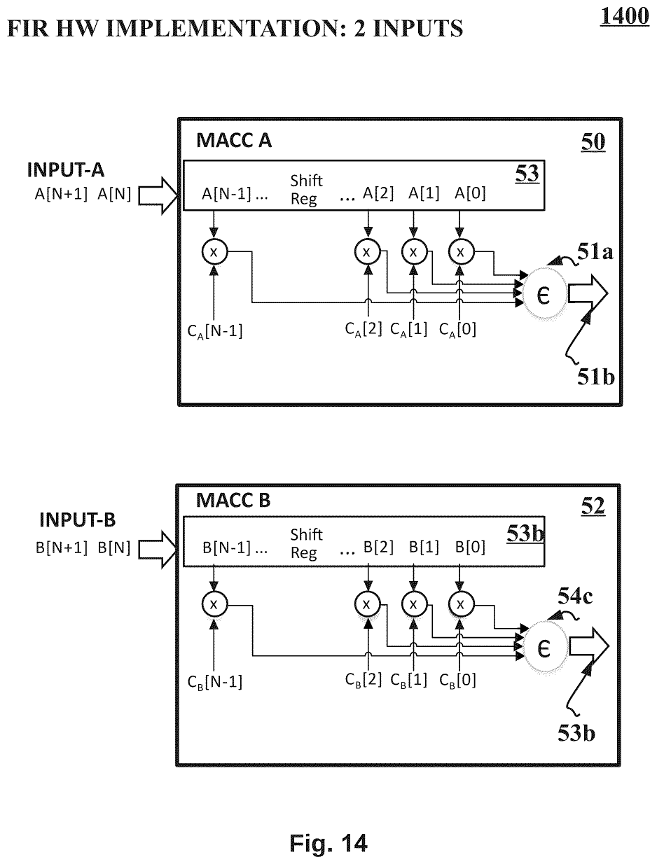

FIG. 14 is an example block diagram 1400 of a finite infinite response (FIR) implementation of two multiply accumulators 50 and 52 having an A and B inputs.

Input-A enters shift-register 53 in the multiply accumulator 50 which has output taps connected to multipliers. The shift-register 53 output taps multiply with the weights C_{A}[N−1 . . . 0]. An accumulator 51a connects to the outputs of the multipliers and output the sum to 51b. As an example, there are five taps implementing a symmetric discrete-time FIR with coefficients C_{A}[N−1 . . . 0]=[−0.03,0.46,0.76,0.46,−0.03], which implement a square-root-raised-cosine (SRRC) with roll-off 0.15 FIR.

Input-B enters shift-register 53b in the multiply accumulator 52 and has output taps connected to multipliers. The shift-register 53b output taps multiply with the weights C_{B}[N−1 . . . 0] . . . . An accumulator 54c connects to the outputs of the multipliers and outputs the sum to 53b. As an example, there are five taps implementing a symmetric discrete-time FIR with coefficients C_{B}[N−1 . . . 0]=[−0.05,0.45,0.77,0.45,−0.05], which implement a SRRC filter with a roll-off of 0.25.

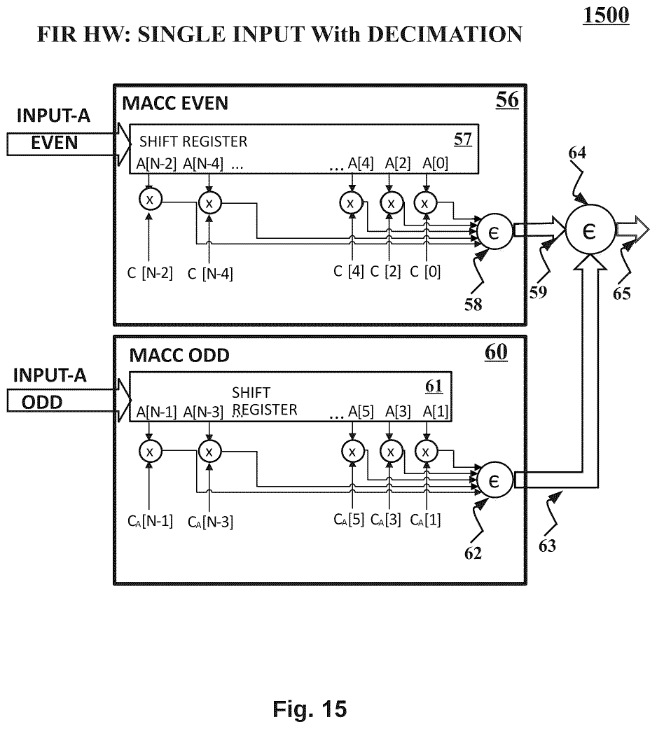

FIG. 15 is an example block diagram 1500 of an FIR implementation where a single signal that consists of even and odd inputs enters two multiply accumulators implementing decimation. 2×N/2 taps long MACC-s are used as a single N long FIR with decimations having 1 output sample per input,

Input-A EVEN enters shift-register 57 in the multiply-accumulator 56 and has output taps connected to multipliers. The shift-register 57 output taps are multiplied with the weights C_{A-EVEN}[N−2, N−4 . . . 0]. An accumulator 58 connects to the outputs of the multipliers and outputs the sum to 59. As an example, there are five taps with coefficients C_{A-EVEN}[N−2, N−4 . . . 0]=[−0.06,0.19,0.65,0.14,−0.08]

Input-A ODD enters shift-register 61 in the multiply accumulator 60 and has output taps connected to multipliers. The shift-register 61 output taps multiply with the weights C_{A-ODD}[N−1, N−3 . . . 1]. An accumulator 62 connects to the outputs of the multipliers and outputs the sum to 63. As an example, there are five taps with coefficients C_{A-ODD}[N−1, N−3 . . . 1]=[−0.08,0.14,0.65,0.19,−0.06].

The accumulator even and odd outputs 59 and 63 enter a third accumulator 64 and the output is 65. In this example, the five taps of each MACC combine to implement a 10 taps SRRC FIR with a roll-off of 0.15.

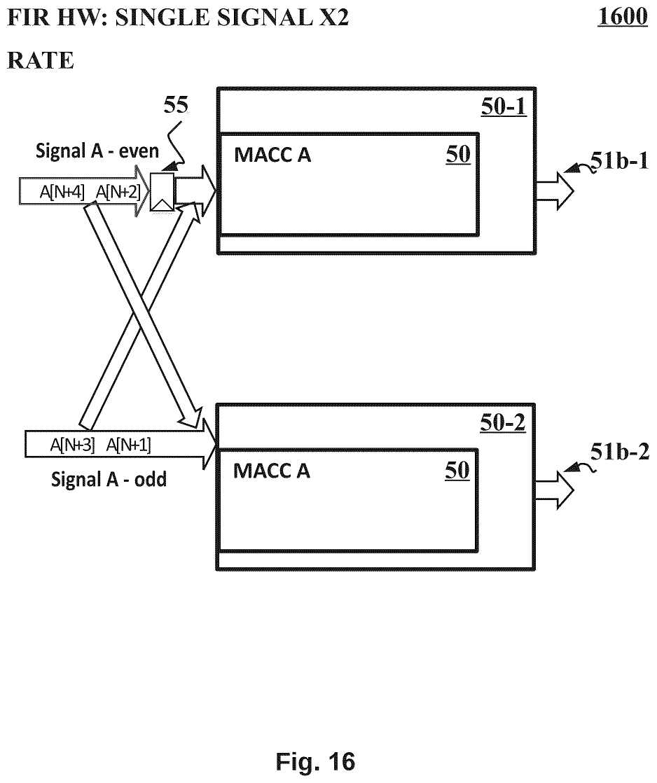

FIG. 16 is an example block diagram 1600 of a FIR implementation operating at double rate. The even and odd inputs, each operating at single rate, enter two MACCs. Input Signal-A EVEN and Input Signal-A ODD are cross coupled to the inputs of the MACCs 50-1 and 50-2. Two N tap long MACC-s implement a single N long FIR with double rate having 2 output samples per 2 input samples.

Input-A EVEN enters, via delay element 55, the instantiation 50-1 having a shift-register 53 disposed in the MACC block 50, whose output taps are multiplied with the weights C_{A-EVEN}[N−1 . . . 0]. The accumulator 51a sums the outputs of the multipliers to 51b-1 (which is the even output samples).

Input-A ODD enters the instantiation 50-2 shift-register 53 disposed in the MACC 50, whose output taps are multiplied with the weights C_{A-ODD}[N−1 . . . 0]. The accumulator 51a sums the outputs of the multipliers to 51b-2 (which is the odd output samples). As an example, both C_{A-ODD}[N−1 . . . 0] and C_{A-EVEN}[N−1 . . . 0] are configured to the values [−0.03,0.46,0.76,0.46,−0.03], so the outputs 51b-1 and 51b-2 are the even and odd outputs of an SRRC symmetric FIR with a roll-off of 0.15.

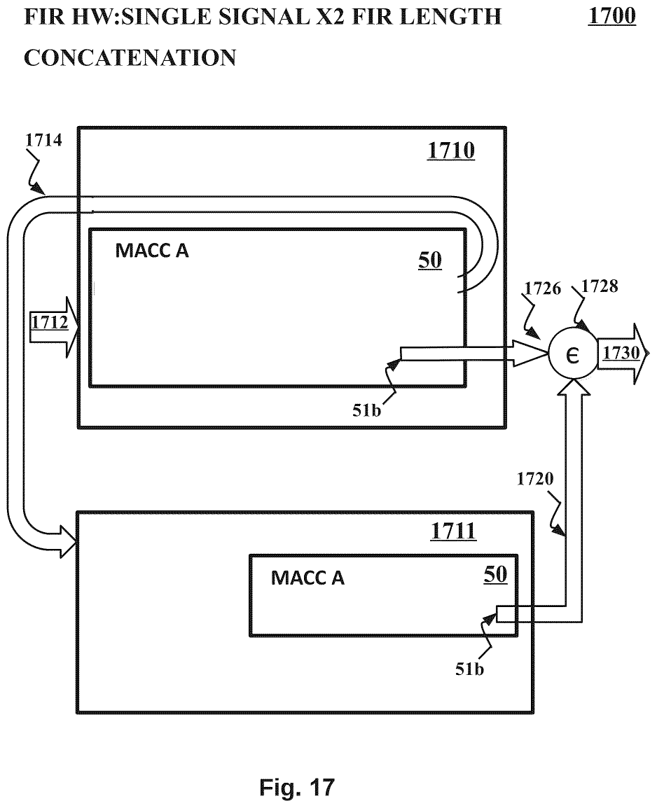

FIG. 17 shows an example 1700 of a 2×N taps FIR implementation with a single input signal connected to two MACCs, each with N number of taps, using concatenation. The input 1712 enters shift-register 53 disposed in the MACC 50 inside 1710, whose taps are multiplied with the weights C_{A-LEFT}[N−1 . . . 0]. The output of the shift register 53 is the input to the shift-register 53 disposed in the MACC 50 inside 1711, whose taps are multiplied with the weights C_{A-RIGHT}[N−1 . . . 0]. The block 1710 MACC A 51b output couples to bus 1726 and the block 1711 MACC A 51b output couples to 1720, and enter an accumulator 1728 to yield the output of a 2×N taps long FIR 1730.

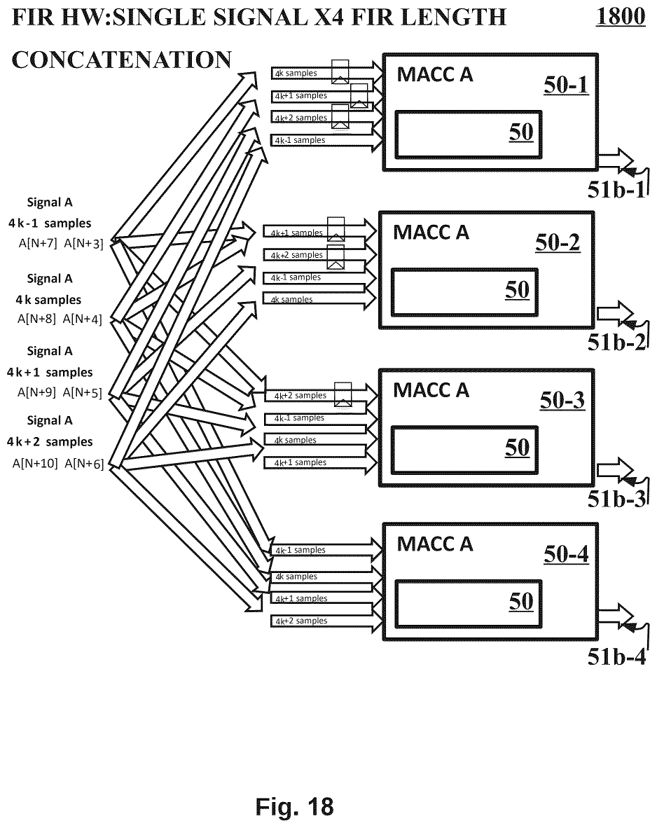

FIG. 18 shows an example 1800 of a single quad-rate N taps FIR, whose input consists of four signals each operating at single rate. Four MACCs, 50-1 . . . 50-4, are used to yield the FIR, whose output is over buses 51b-1 . . . 51b-4, each operating at single rate.

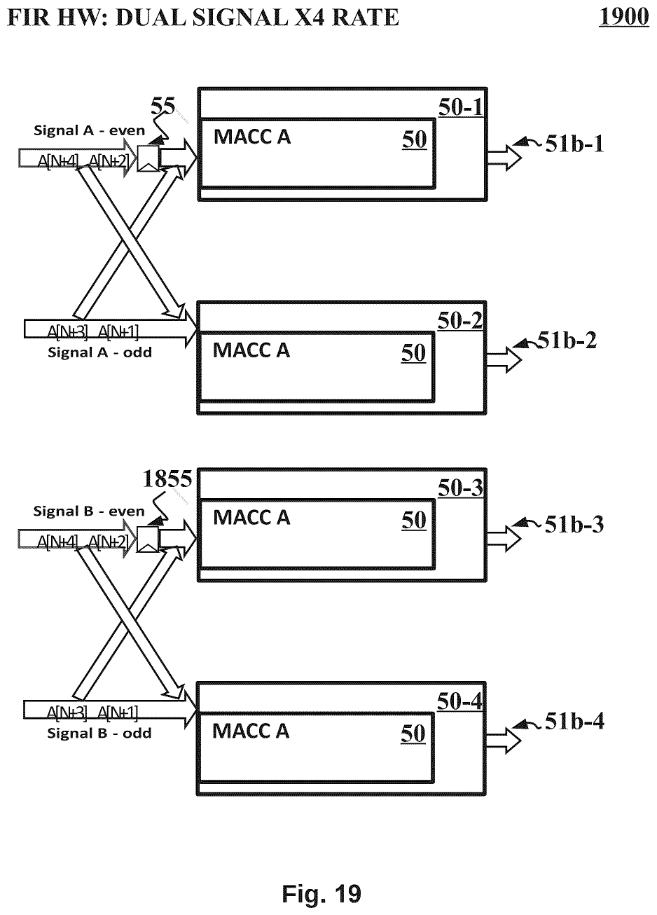

FIG. 19 shows an example 1900 of two double-rate N taps FIRs, whose inputs consist of two couples of signals operating each at double rate. Four MACCs, 50-1 . . . 50-4, are driven through delay elements 55 and 1855, and are used to yield the two FIRs. The outputs of the first FIR are over buses 51b-1 and 51b-2 operating each at single rate. The outputs of the second FIR are over buses 51b-3 and 51b-4 operating each at single rate.

Table-1 below summarizes FIGS. 14-19.

TABLE 1

| | | | FIR Input | | Output | |
|---|---|---|---|---|---|---|
| Figure | | | Rate | Signals | Rate | Taps |
| FIG. 14 | 2 | X | X | 2 | X | N |
| FIG. 15 | 2 | X | 2X | 1 | X | 2N |
| FIG. 16 | 2 | X | 2X | 1 | 2X | N |
| FIG. 17 | 2 | X | X | 1 | X | 2N |
| FIG. 18 | 4 | X | 4X | 1 | 4X | N |
| FIG. 19 | 4 | X | 2X | 2 | 2X | N |

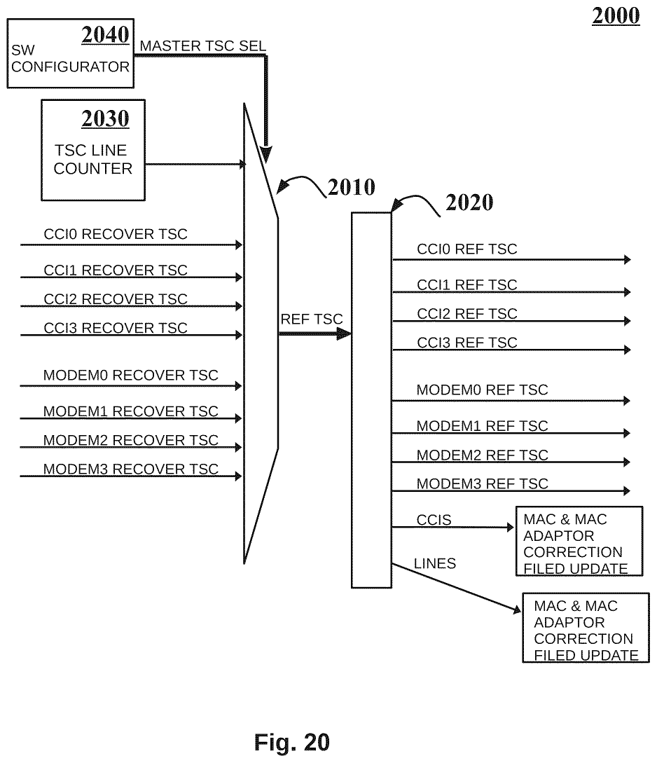

FIG. 20 shows an example schematic 2000 for a clock synchronizer circuit for a plurality of interfaces and capable to select the best clock from the plurality of clock sources. The clock synchronizer circuit provides a single source clock circuit comprising an IEEE 1588-time stamper counter; Synchronous Ethernet (Sync-E) compliance; and Precision Time Protocol (PTP). Each line interface can be a source, or each modem can be a source. In some aspects, each CCI interface connection can be a source depending on PTP direction for synchronization.

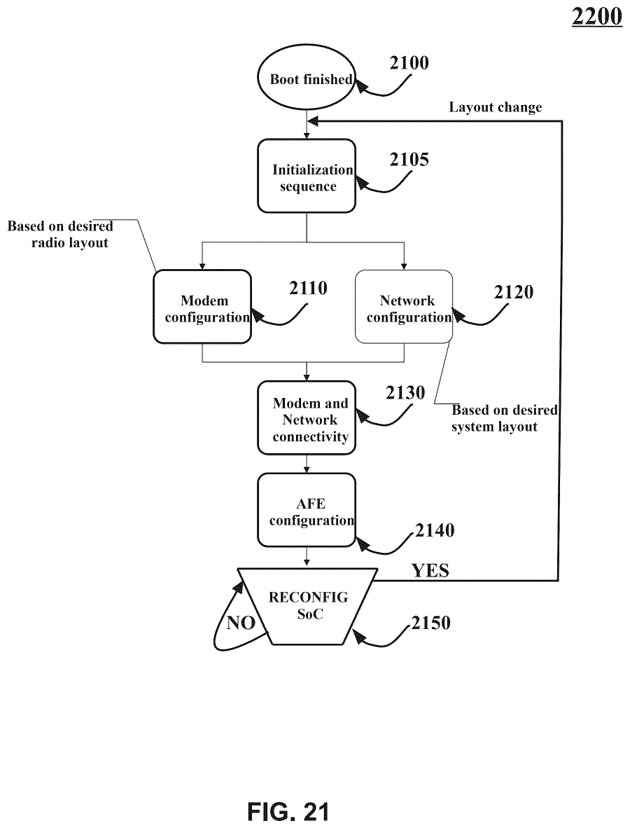

FIG. 21 is a high-level flowchart showing a method for a computer implemented method for initializing the System on Chip having a configurable transceiver, the method comprising the following steps. At step 2100, complete a Host Sub-System boot sequence to accept at least one API call for the Sub-System configurations. At step 2105, start the initialize sequence. At step 2110, at least one API configures the Modem Sub-System configuration according to the required radio layout. At step 2120, initialize the Network Sub-System configuration according to the required system layout in response to at least one API call. The configuration of the NSS can be before or after the MSS configuration. At step 2130, connect the Modem Sub-System to the Network Sub-System in response to the at least one API call. At step 2140, initialize an analog front end configuration connected to the Modem Sub-System in response to the API call. At step 2150, looping to decide, or test whether a change of the system configuration required due to desired change of radio layout or system layout.

It is noted triggering APIs for a layout change request supports a change in configuration to any configuration supported by the SoC.

It is expected that during the life of a patent maturing from this application many relevant data points for latency will be developed and the scope of the term load balancing is intended to include all such new technologies a priori.

As used herein with reference to quantity or value, the term “about” means “within ±10% of”.

The terms “comprising”, “including”, “having” and their conjugates mean “including but not limited to”.

The term “consisting of” is intended to mean “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a unit” or “at least one unit” may include a plurality of units, including combinations thereof.

The words “example” and “exemplary” are used herein to mean “serving as an example, instance or illustration”. Any embodiment described as an “example or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Throughout this application, various embodiments of this disclosure may be presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween.

Unless otherwise indicated, numbers used herein and any number ranges based thereon are approximations within the accuracy of reasonable measurement and rounding errors as understood by persons skilled in the art.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A System on Chip (SoC) having a configurable receiver comprising:
a Network Sub-System connected to a network;
a Modem Sub-System coupled to the Network Sub-System, the Modem Sub-System comprising a receiver circuit having multiplexing circuits and control hardware for providing parallel hardware units for processing low bandwidth signals; and
a Host Sub-System having a processor coupled to the network, the Network Sub-System, and the Modem Sub-System, wherein in response to an application programming interface (API) call from the network, the Host Sub-System configures the Network Sub-System and configures the Modem Sub-system.

2. The System on Chip of claim 1, wherein the API call is to configure:
the Modem Sub-System multiplexing circuits and control hardware;
the Network Sub-System for packet processing and radio bonding; and
to enable at least one Ethernet port.

3. The System on Chip of claim 1, wherein configuring the Network Sub-System is for connecting a plurality of line configurations to the network.

4. The System on Chip of claim 1, wherein configuring the Modem Sub-System is having a receiver circuit for at least one of a microwave frequency; a D-Band frequency; or an E-band frequency.

5. The System on Chip of claim 4, wherein the Modem Sub-System having parallel hardware units are a plurality of finite impulse response (FIR) filter implementations-allowing cross polarization interference cancelation (XPIC); carrier aggregation; decimation and bi-directional side-lobe cancellation.

6. The System on Chip of claim 5, wherein the plurality of FIR filters can concatenate to increase the number of FIR taps.

7. The System on Chip of claim 1, further comprising a cross-connect interface (CCI) bus for the sharing of data and configuration commands between at least two SoCs and wherein the CCI bus is configured by an API call.

8. The System on Chip of claim 1, wherein the CCI couples a plurality of configurable receivers and network channels.

9. The System on Chip of claim 8, wherein one configurable receiver is a master and at least one configurable receiver is a slave.

10. The System on Chip of claim 9, wherein the CCI couples at least two configurable receivers having at least one output port.

11. A System on Chip having a configurable transmitter comprising:
a Network Sub-System connected to a network;
a Modem Sub-System coupled to the Network Sub-System, the Modem Sub-System comprising a transmitter circuit having multiplexing circuits and control hardware for providing parallel hardware units for processing low bandwidth signals; and
a host subsystem having a processor coupled to the network, the Network Sub-System, and the Modem Sub-System, for configuring the Network Sub-System and for configuring the Modem Sub-System in response to an application programming interface (API) call from the network.

12. The System on Chip of claim 11, wherein the API call is to configure:
the Modem Sub-System multiplexing circuits and control hardware;
an Ethernet channel connection to a carrier for the Network Sub-System;
and enable an Ethernet port.

13. The System on Chip of claim 11, wherein configuring the Network Sub-System is for packet processing, radio bonding, and connecting a plurality of line configurations to the network.

14. The System on Chip of claim 11, wherein configuring the Modem Sub-System is having a transmitter circuit for at least one of a microwave frequency; a D-Band frequency; or an E-band frequency.

15. The System on Chip of claim 14, wherein Modem Sub-System is having parallel hardware units are a plurality of FIR filter implementations allowing carrier aggregation; bi-directional side-lobe cancellation, and beam-forming.

16. The System on Chip of claim 15, wherein the plurality of FIR filters can concatenate to increase the number of FIR taps.

17. The System on Chip of claim 11, further comprising a cross-connect interface (CCI) bus for the sharing of data and configuration commands between at least two SOCs and wherein the CCI bus is configured by an API call.

18. The System on Chip of claim 17, wherein the CCI couples a plurality of configurable transmitters configured for parallel transmitting.

19. The System on Chip of claim 18, wherein one configurable transmitter is configured as a master and coupling to at least one configurable transmitter configured as a slave.

20. The System on Chip of claim 19, wherein the CCI couples at least two configurable transmitters configured for parallel transmitting with at least one input port.

21. The System on Chip of claim 11, further comprising a clock synchronizer circuit for interfacing to several clock sources and capable to select the best clock source, the clock synchronizer circuit configured by an API call.

22. A method for initializing a System on Chip having a configurable transceiver comprising:
a) completing a Host Sub-System boot sequence to accept an API call for a Sub-Systems configurations;
b) initializing sequence;
c) initializing a Modem Sub-System configuration using a radio layout in response to the API call;
d) initializing a Network Sub-System configuration using a system layout in response to the API call;
e) connecting the Modem Sub-System to the Network Sub-System;
f) initializing an analog front-end configuration connected to the Modem Sub-System in response to the API call;
g) testing whether a layout change request from the API call is true or false;
h) based in the test of the layout change request yielding true, then do (b);
i) based in the test of the layout change request yielding false, then do (g).
